(19) United States
(12) Patent Application Publication
(10) Pub. No.: US 2005/0111082 A1
(43) Pub. Date: May 26, 2005

(54) Confocal microscopy arrangement without beam splitter

(75) Inventor: Jacob Karin, Ramat Gan (IL)

Correspondence Address: DR. MARK FRIEDMAN LTD.;c/o Bill Polkinghorn, Discovery Dispatch, 9003 Florin Way, Upper Marlboro, MD, 20772, US

(73) Assignee: Accretech (Israel) Ltd.

(21) Appl. No.: 10/716,552

(22) Filed: Nov. 20, 2003

(51) Int. Cl. G02B 21/00

(52) U.S. Cl. 359/358; 359/368

(57) ABSTRACT

A microscope arrangement for simultaneously inspecting a plurality of spots on the surface of a substrate includes at least one source of substantially parallel illumination directed non-parallel to the optical axis, an optical arrangement configured for directing the substantially parallel illumination to illuminate spaced apart spots on the surface of the substrate and for returning radiation from the spots, and an array of optical sensors. The optical arrangement includes an array of reflectors located and angled so as to generate an array of spaced illumination beams generally parallel to the optical axis, each reflector reflecting at least 90% of incident radiation intensity. Each of the optical sensors is spatially associated with a corresponding at least one of the reflectors so as to receive at least part of the radiation returned from the spot illuminated by the corresponding reflector.

### FIELD AND BACKGROUND OF THE INVENTION

The present invention relates to microscopy and, in particular, it concerns a confocal microscopy arrangement which avoids the use of beamsplitters.

It is known to employ confocal microscopy for high-resolution inspection of surfaces. The essence of confocal microscopy or confocal imaging is described in U.S. Pat. No. 3,013,467 to Minsky in which light from a point or small spot illumination source (pinhole) is focused to a small spot on the specimen and light reflected (or transmitted) from the illuminated spot is in turn focused to a small spot (pinhole) sensor. This configuration may be combined with a scanning system to build up a high resolution image of a specimen, for example, a semiconductor wafer. Further examples of confocal microscopy may be found in U.S. Pat. Nos. 4,806,004; 5,239,178; and 6,285,019.

In order to increase efficiency in a scanning confocal system, multi-spot arrangements are typically used. An example of such a system may be found in U.S. Pat. No. 5,239,178 to Derndinger et al., FIG. 1 of which is reproduced herein as FIG. 1. (A detailed description of the elements identified by reference numerals therein may be found in the Deindinger et al. patent itself. Said description is hereby incorporated by reference and, for the sake of conciseness, will not be reproduced here.) In this typical case, a multi-spot confocal microscope configuration in implemented using an array of pinholes, with or without an accompanying lens array, in front of an extended source of light to generate a plurality of point sources. These point sources are then brought into focus on the sample by the action of an objective lens. The reflected beams are directed back through another matching array of pinholes.

Co-assigned co-pending U.S. patent application Ser. No. 10/230,207, which is hereby incorporated by reference in its entirety, discloses the use of a diffractive optical element (“DOE”) to generate a virtual pinhole array illumination pattern with much greater efficiency than a physical pinhole array. It should be noted that the aforementioned application is unpublished on the date of tiling of this application and that this reference to the application should not in any way be construed as an admission of prior art.

A common characteristic of all confocal microscopy arrangements known to the inventor is the use of a beam-splitter (labeled 16 in the Derndinger patent drawing reproduced as FIG. 1) to separate the optical paths of the illumination and sensor arrangements. Thus, in the example shown here, the source illumination reaches the sample by transmission through the beam-splitter while returned radiation reaches the detector by reflection at the beam-splitter. The beam-splitter essentially introduces at least 75% illumination intensity losses into the system, halving both the illumination beams and the radiation returned from the sample. Where a white light source (i.e., a lamp) can be used, this inefficiency is not critical since these losses can be compensated for by using high power light source. However, as resolution requirements increase, shorter wavelength illumination is required, typically in the UV or DUV (Deep UV) spectral range. In these ranges, strong light sources are not readily available. For example, A CW laser with output at 266 nm is currently available at only 0.5 watt output.

There is therefore a need for a confocal microscope arrangement which would avoid at least part of the illumination intensity losses inherent to use of a beam-splitter.

### SUMMARY OF THE INVENTION

The present invention is a microscope arrangement.

According to the teachings of the present invention there is provided, a microscope arrangement for simultaneously inspecting a plurality of spots on the surface of a substrate, the arrangement having an optical axis substantially perpendicular to the surface, the arrangement comprising: (a) at least one source of substantially parallel illumination directed non-parallel to the optical axis; (b) an optical arrangement configured for directing the substantially parallel illumination to illuminate spaced apart spots on the surface of the substrate and for returning radiation from the spots, the optical arrangement including an array of reflectors located and angled so as to generate an array of spaced illumination beams substantially parallel to the optical axis, each reflector reflecting at least 90% of incident radiation intensity; and (c) an array of optical sensors, each of the sensors being spatially associated with a corresponding at least one of the reflectors so as to receive at least part of the radiation returned from the spot illuminated by the corresponding reflector.

According to a further feature of the present invention, the at least one source of illumination is implemented as a single source of illumination.

According to a further feature of the present inventions the at least one source of illumination is configured to provide illumination having a wavelength no greater than 266 nm.

According to a further feature of the present invention, the array of reflectors and the array of optical sensors are arranged on a common substrate.

According to a further feature of the present invention, each of the reflectors is adjacent to the corresponding one of the optical sensors.

According to a further feature of the present invention, each of the optical sensors has a pair of the reflectors deployed on opposing sides of the optical sensor, and wherein the at least one source of substantially parallel illumination provides illumination in two incident directions.

According to a further feature of the present invention, each of the reflectors has a reflective surface with an aperture formed therein, wherein the corresponding one of the optical sensors is deployed to receive radiation returned from the spot via the aperture.

According to a further feature of the present invention, wherein the optical arrangement further includes a diffractive optical element deployed for generating a plurality of illuminating radiation beams, each of the beams being directed towards one of the reflectors, each of the radiation beams having a non-uniform intensity distribution such that a proportion of the radiation intensity falling on the reflective surface around the aperture is greater than a ratio of the reflective surface area to the aperture area.

According to a further feature of the present invention, wherein the optical arrangement further includes a diffractive optical element deployed for generating a plurality of illuminating radiation beams, each of the beams being directed towards one of the reflectors.

According to a further feature of the present invention wherein the optical arrangement further includes a microlens associated with each of the reflectors and deployed to focus parallel illumination to provide a pinhole illumination effect.

According to a further feature of the present invention, wherein each of the reflectors has a reflecting surface, a normal to the reflecting surface being at 45° to the optical axis.

According to a further feature of the present invention each of the reflectors has a reflecting surface, a normal to the reflecting surface being at less than 45° to the optical axis.

According to a further feature of the present invention, the substrate has a base plane, wherein a plurality of the reflectors are mounted at differing heights above the base plane.

### BRIEF DESCRIPTION OF THE DRAWINGS

The invention is herein described, by way of example only, with reference to the accompanying drawings, wherein:

FIG. 1 is a schematic side view of a conventional confocal microscope system;

FIG. 2 is a schematic simplified illustration of a first microscope arrangement, constructed and operative according to the teachings of the present invention, taken parallel to a direction of an input illumination beam;

FIG. 3 is a schematic view similar to FIG. 2 taken perpendicular to the input illumination beam;

FIGS. 4A and 4B are schematic side and plan views, respectively, of a first arrangement of reflectors and radiation sensors for use in the microscope arrangement of FIGS. 2 and 3;

FIGS. 5A and 5B are schematic side and plan views, respectively, of a second arrangement of reflectors and radiation sensors for use in the microscope arrangement of FIGS. 2 and 3;

FIGS. 6A, 6B and 6C are schematic illustrations of geometrical relations between the illumination beams and the returned radiation reaching the radiation sensor according to various implementations of the microscope arrangement of FIGS. 2 and 3;

FIG. 7 is a schematic isometric view of a further arrangement of reflectors and radiation sensors for use in the microscope arrangement of FIGS. 2 and 3 employing reflectors inclined at 45° to the optical axis;

FIG. 8 is a schematic isometric view of a further arrangement of reflectors and radiation sensors for use in the microscope arrangement of FIGS. 2 and 3 employing reflectors inclined at less than to the optical axis;

FIGS. 9A and 9 are schematic side and plan views, respectively, of a still further arrangement of reflectors and radiation sensors for use in the microscope arrangement of FIGS. 2 and 3 in which the reflectors are mounted at differing heights above a base plane of a substrate:

FIG. 10 is a schematic simplified illustration of a second microscope arrangement, constructed and operative according to the teachings of the present invention employing a mirror with an aperture in its reflective surface;

FIG. 11 is a schematic isometric view of part of a reflector and optical sensor arrangement for use in the microscope arrangement of FIG. 10; and

FIG. 12 is a schematic illustration of enhancement of the microscope arrangement of FIG. 10 by use of a non-uniform beam intensity produced by a diffractive optical element.

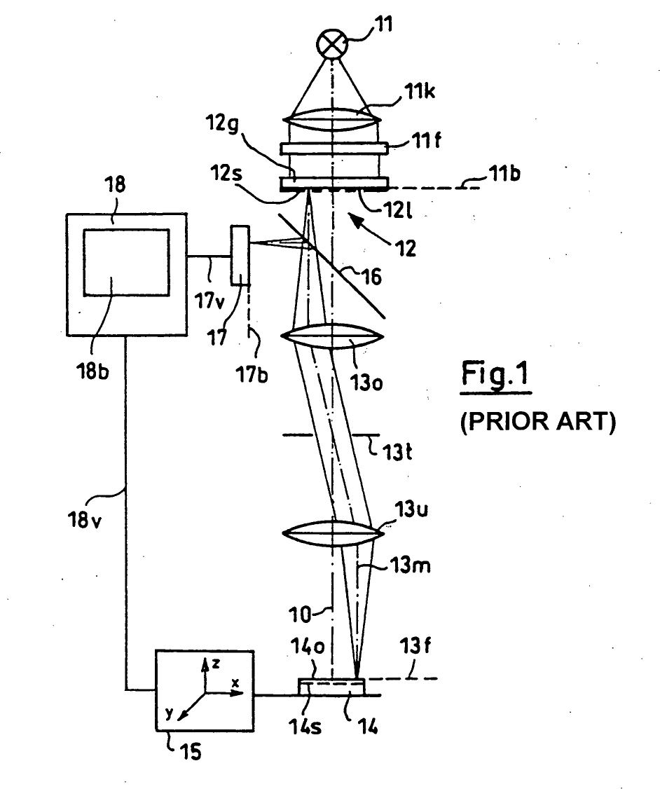

### DESCRIPTION OF THE PREFERRED EMBODIMENTS

The present invention is a confocal microscopy arrangement which avoids the use of beamsplitters.

The principles and operation of microscope arrangements according to the present invention may be better understood with reference to the drawings and the accompanying description.

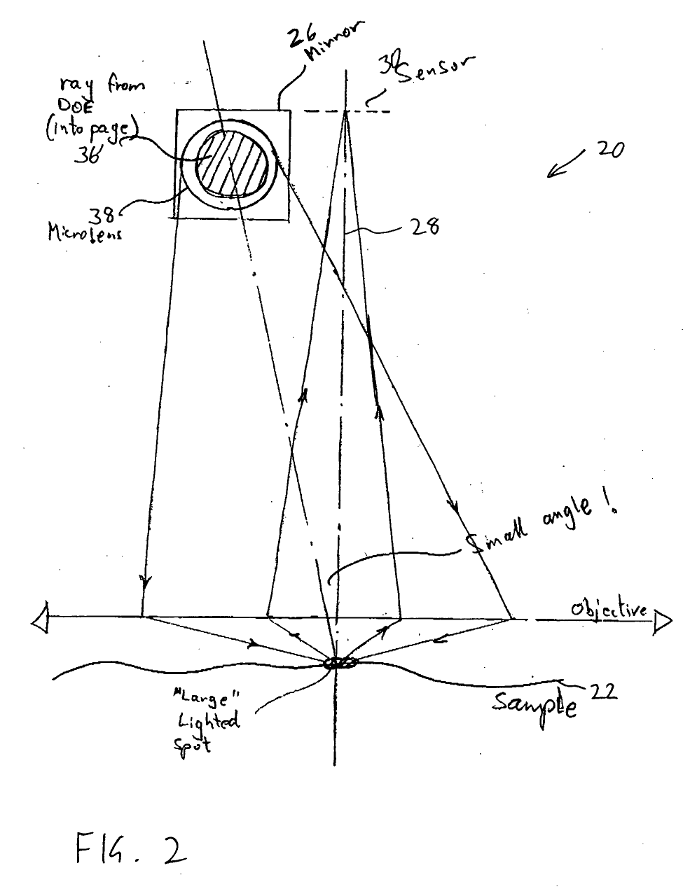

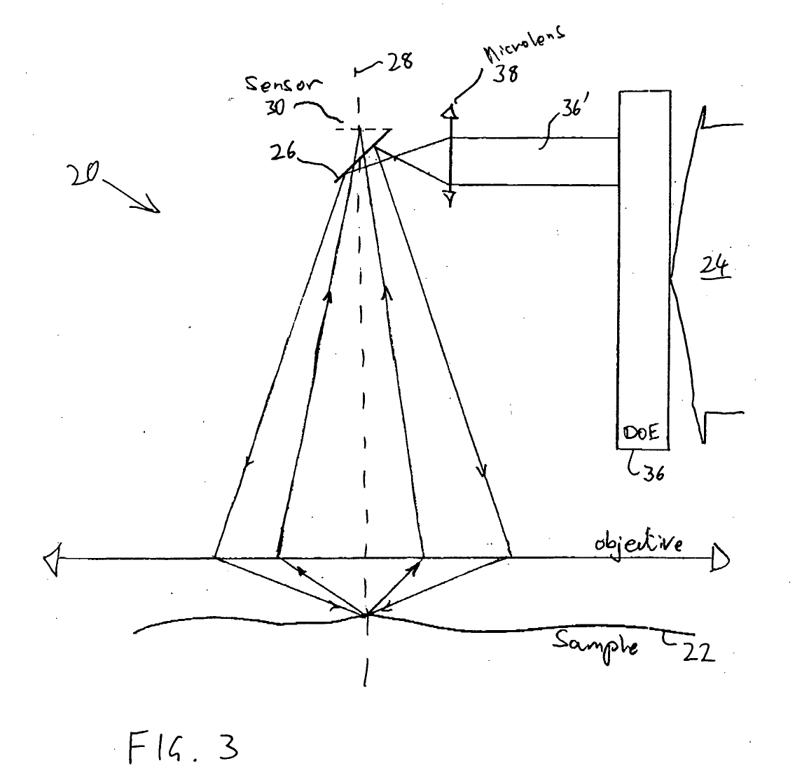

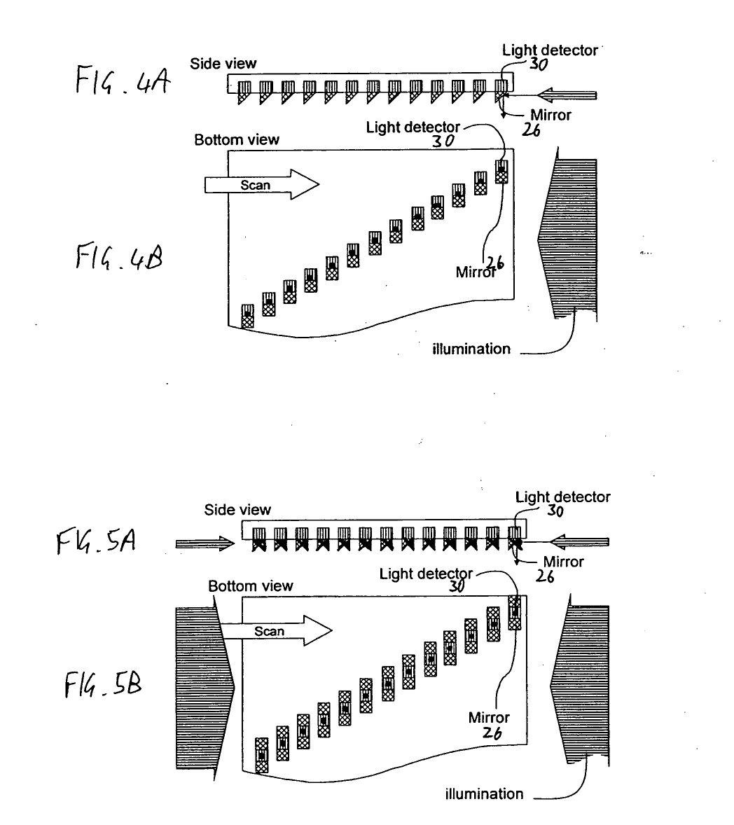

Referring now to the drawings, FIGS. 2 and 3 show schematically the optical arrangement for a single detector of a microscope arrangement, generally designated 20, constructed and operative according to the teachings of the present invention, for simultaneously inspecting a plurality of spots on the surface of a substrate 22. Generally speaking, microscope arrangement 20 includes one or more source of substantially parallel illumination, represented here by wide arrow 24 in FIG. 3 and an optical arrangement configured for directing the substantially parallel illumination to illuminate spaced apart spots on the surface of the substrate and for returning radiation from the spots. The optical arrangement includes an array of reflectors 26 (only one being shown in FIGS. 2 and 3 for clarity of illustration) located and angled so as to generate an array of spaced illumination beams substantially parallel to an optical axis 28 of the optical system. Microscope system 20 further includes an array of optical sensors 30 (only one shown here), each of which is spatially associated with a corresponding one or more of reflectors 26 so as to receive at least part of the radiation returned from the spot on sample 22 illuminated by the corresponding reflector 26. In practice, there is preferably an array of spaced optical sensors 30 each with at least one associated reflector 26. An example of a single reflector per sensor arrangement is shown schematically in FIGS. 4A and 4B, while a two-reflector per sensor arrangement is shown schematically in FIGS. 5A and 5B. The mirrors are preferably positioned immediately adjacent to the sensor, although they are shown here schematically somewhat separated for clarity of presentation. The structure can similarly be implemented with three or four reflectors for each sensor.

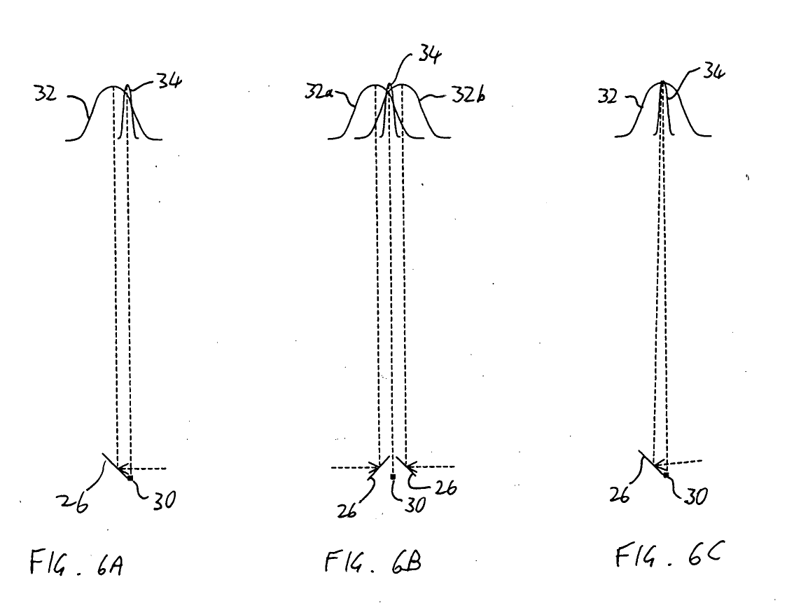

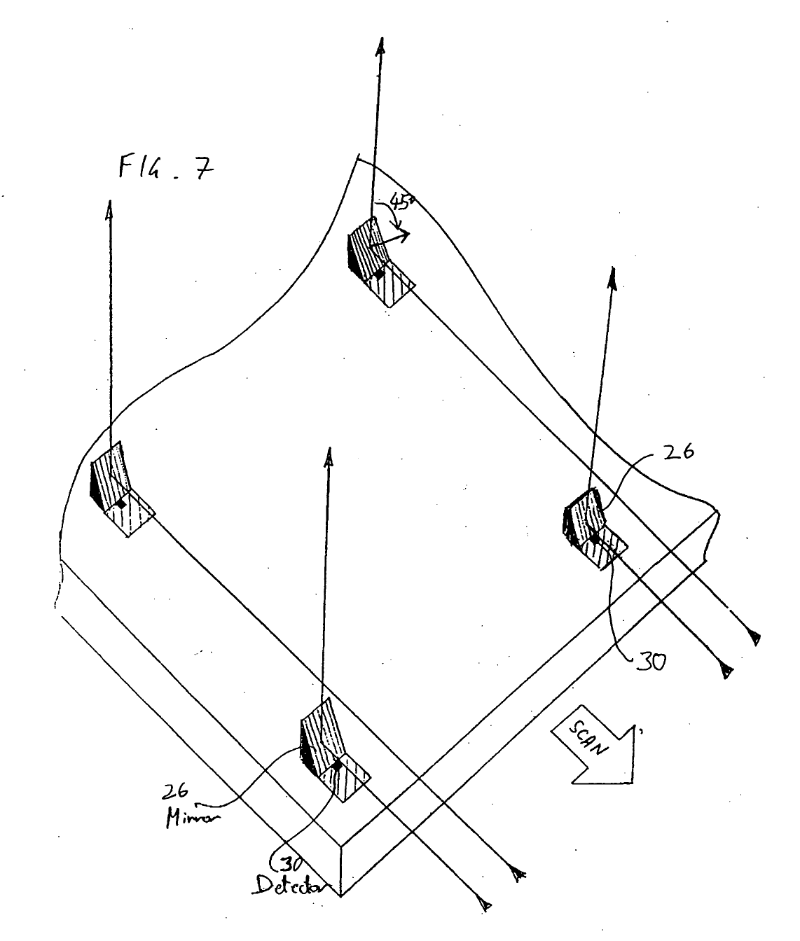

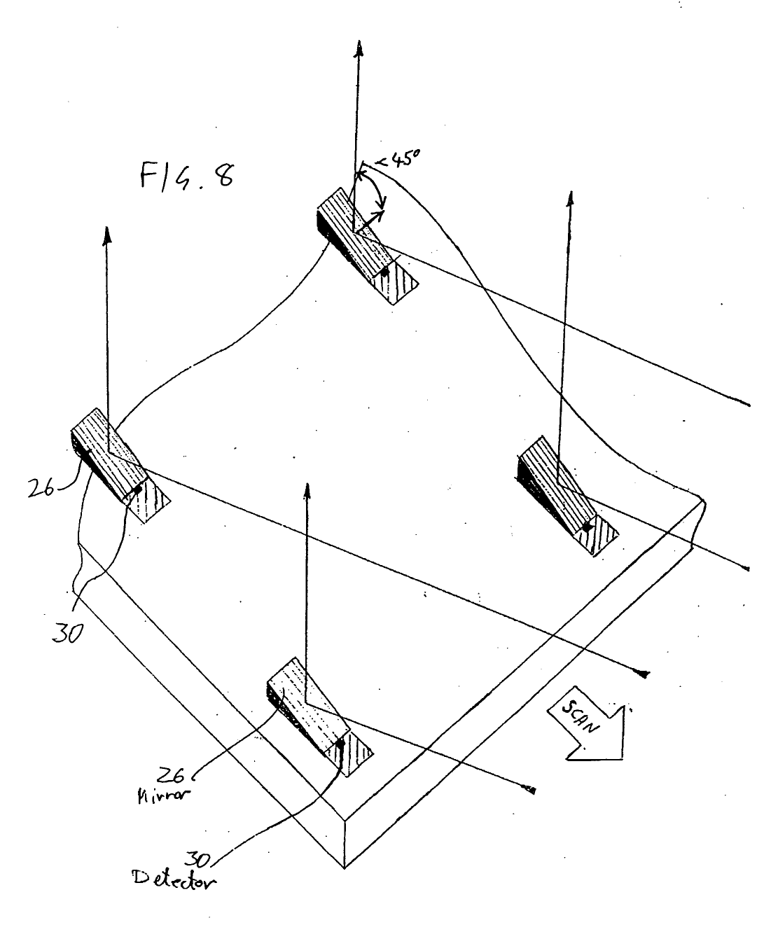

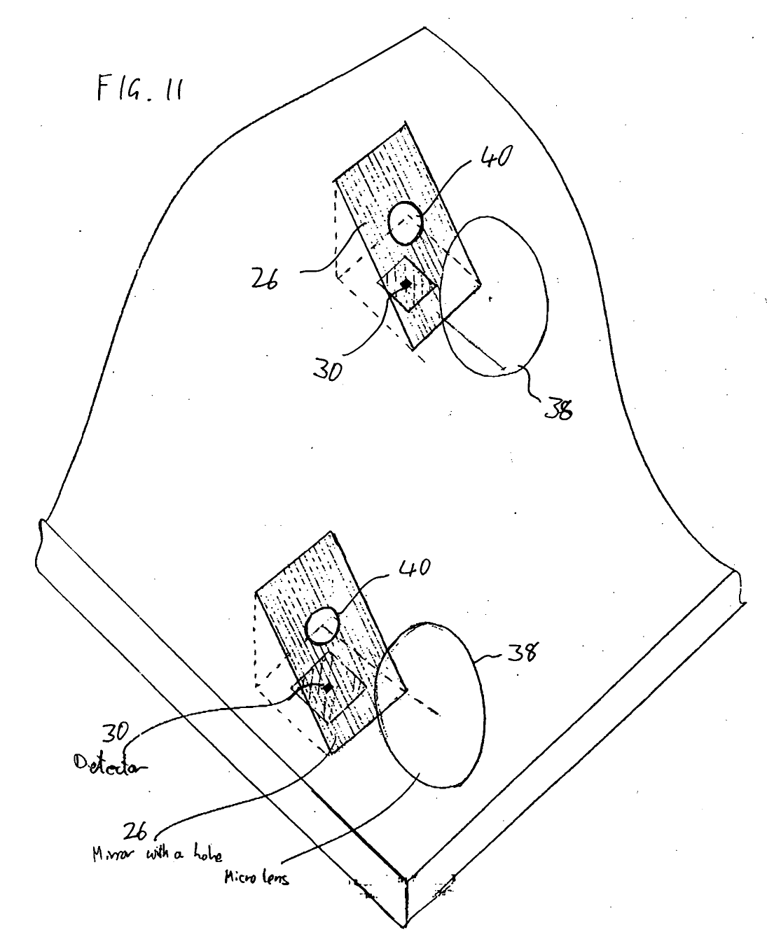

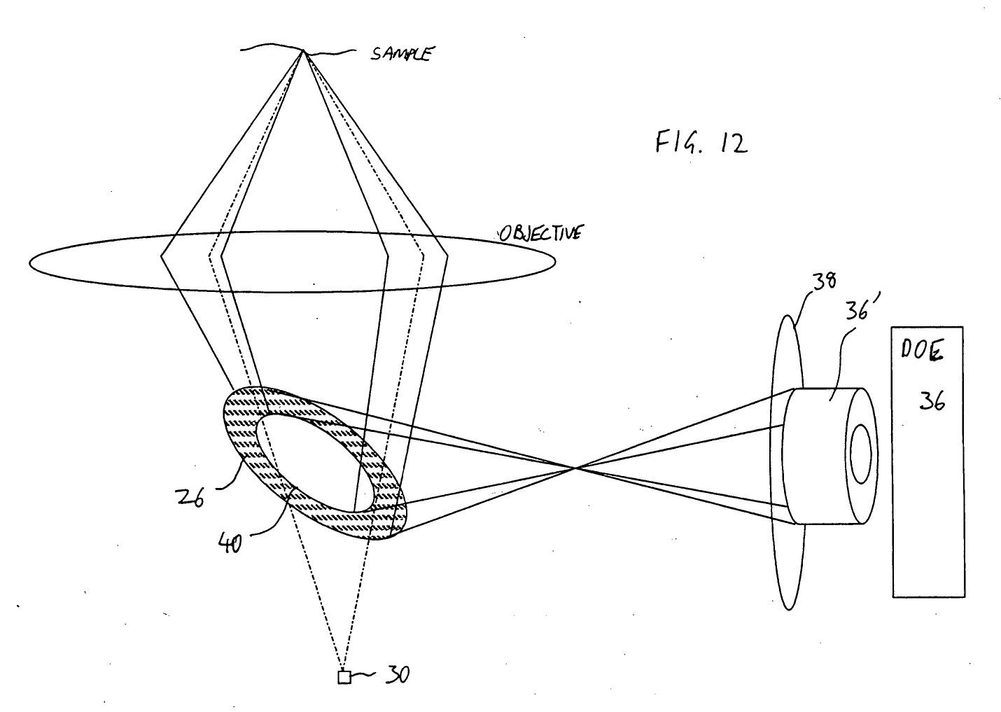

It should be appreciated that it is a particular feature of the “reflectors” of the present invention that they reflect at least 90%, and preferably well over 95%, of incident radiation intensity in the operating wavelengtlh range of the microscope arrangement. By using high reflectivity elements instead of the conventional beam-splitter, the aforementioned intensity losses associated with beam-splitters are avoided. The slight lateral “misalignment” between the reflectors and the sensors is accommodated as will now be described with reference to FIGS. 6A-6C. Parenthetically, it should be noted that the alternative implementation described below with reference to FIGS. 10-12 completely avoids misalignment of optical paths from the reflector to the sample and returning from the sample to the sensor.

Turning now to FIG. 6A, it should be noted that the spot size of illumination used in confocal microscopy, particularly in short wavelength implementations, is typically significantly larger than the spot size selected by the pinhole-limited sensor elements. In FIG. 6A, this is represented by an illumination intensity profile 32 and a detector sensitivity distribution profile 34. So long as the narrower detector sensitivity distribution profile 34 falls within the “spot” of the illumination intensity profile 32, it is not essential that their optical axes coincide. This allows positioning of a sensor immediately adjacent to the reflector used for illumination beam as shown in FIG. 6A.

FIG. 6B is similar to FIG. 6A, but shows the illumination intensity profiles 32a and 32b generated by a pair of reflectors adjacent to a sensor, similar to the reflector arrangement of FIGS. 5A and 5B. In this case, the adjacent illumination spots overlap to give maximum illumination intensity at the center of the detector sensitivity profile 34.

FIG. 6C shows a further option corresponding to the ray pattern illustrated in FIG. 2. In this case, the illumination beam is deflected at a small angular deviation from the optical axis of the microscope so as to center the illumination spot 32 substantially at the center of the detector sensitivity distribution profile 34. This deviation may be generated either by slight inclination of the reflective surfaces, or by slight adjustment of the incoming illumination beam direction. It should be noted that the angular deviation involved is exaggerated here and in FIG. 2 for clarity of presentation, but is actually limited to very small angles, typically a small fraction of 1°, such that the optical effects of the deviation from the optical axis are generally negligible.

As mentioned above, the present invention relates primarily to confocal microscopy in which a plurality of spaced apart spots are illuminated and imaged. In this context, “spaced apart” should be understood to refer to a pattern in which a center-to-center distance between adjacent spots is at least about ten times the spot size. It should be noted that the sensor size in the drawings has generally been exaggerated for clarity of presentation, but is preferably implemented sufficiently small to ensure a spot-size to spacing ratio no greater than 1:10 as stated. The ratio of illumination spot size to distance between spots is preferably, although not necessarily, also no more than 1:10.

It should be noted that the present invention is not essentially limited to any particular wavelength of radiation. Thus, the terms “optical”, “light” etc. as used herein should be understood in their broadest sense to refer to electromagnetic radiation and devices pertaining thereto of wavelengths ranging from far infrared through to deep ultraviolet. However, as mentioned earlier, illumination intensity is a particular problem in the deep UV range where the power of available illumination sources is generally very limited. Thus, the present invention is particularly advantageous when implemented using a source 24 of illumination configured to provide illumination having a wavelength no greater than 266 nm.

Clearly, the invention may be implemented with any number of illumination sources. In the case of a single reflector 26 adjacent to each sensor 30 such as illustrated in FIGS. 4A, 4B, 7 and 8, a single illumination source is typically preferred. In this case, the optical arrangement preferably includes a diffractive optical element (DOE) 36 (FIG. 3) deployed for generating a plurality of illuminating radiation beams 36′ (only one shown). Each beam is preferably directed towards one of the reflectors. The design considerations for such a DOE and commercial suppliers of the corresponding technology are discussed in the aforementioned co-assigned co-pending U.S. patent application Ser. No. 10/230.207, which is hereby incorporated by reference in its entirety.

Where two reflectors 26 are adjacent to each sensor 30 such as in the arrangement of FIGS. 5A and 5B, it is typically preferable to double-up the illumination source to provide independent illumination from two opposing directions. This ensures that the two staggered rows of reflectors 26 provide the maximum available un-obscured area of reflective surfaces. Larger numbers of reflectors per sensor and illumination sources may also be used.

In order to maximize the illumination efficiency while providing a pinhole illumination effect, each reflector 26 is preferably provided with a microlens 38 (FIGS. 2 and 3) which focuses incoming parallel illumination beam 36′. The resulting virtual pinhole source formed at the focal point of the microlens is located to approximate to a conjugate point with the optical sensor element 30, subject to the tolerances and/or corrections of FIGS. 6A or 6C discussed above.

Optionally, the effect of microlenses 38 may be emulated by forming reflectors 26 with a suitably curved reflecting surface.

Parenthetically, although the illumination source is described as providing illumination directed “non-parallel to the optical axis” of the microscope arrangement, it will be clear that it is only the stage immediately prior to reflectors 26 which is inherently required to be non-parallel to the axis. The physical location and internal structure of the illumination source per se is of no relevance to the invention, and may include optical paths parallel to the optical axis of the microscope arrangement.

In order to ensure sufficient precision of positioning of reflectors 26 and sensors 30, they are preferably all arranged on a common substrate. Most preferably, all are formed through micro-electronic and micro-mechanical production techniques well known in the art as a unitary structure on a semiconductor chip.

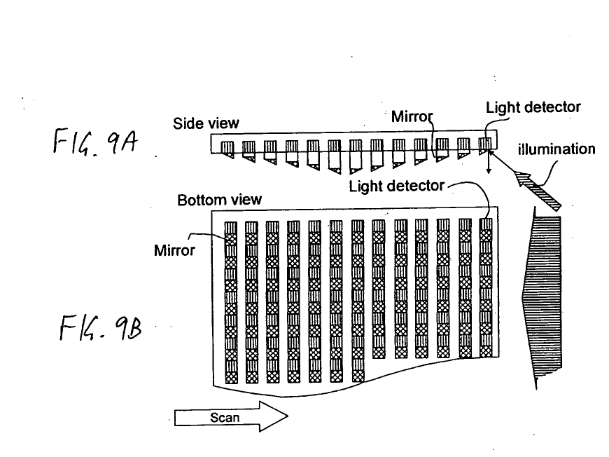

Turning now to FIG. 7, this shows a further geometric arrangement wherein each reflector 26 is located “behind” the corresponding sensor 30, i.e., the reflector is deployed to receive an incident beam passing across the corresponding sensor. This arrangement, in common with the arrangements of FIGS. 4A-4B and 5A-5B, is shown in a first preferred configuration in which a normal to the reflecting surface of each reflector 26 is at 45° to the optical axis. This geometrical arrangement is advantageous in that it allows the illumination beam to be provided parallel to a scanning direction of a scanning carriage (not shown) from an illumination source mounted at an end of the scanning path. In this context, it should be noted that a slight corrective inclination of the type described above with reference to FIG. 6C is much less than a degree and is considered for the purpose of the description and claims to answer to the definition of having a normal at 45° to the optical axis.

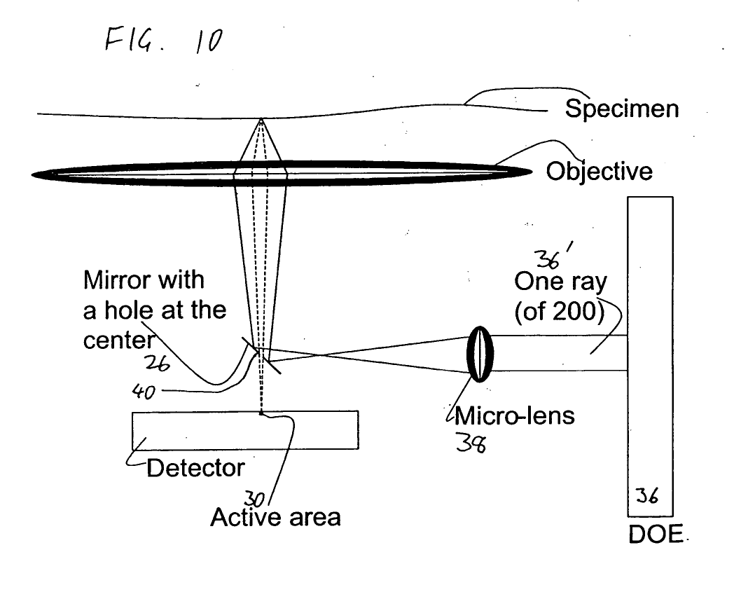

FIG. 8 shows an alternative geometrical arrangement generally similar to that of FIG. 7 but employing reflectors 26 having a normal to the reflecting surface at less than 45° to the optical axis. In this case, the illumination source is arranged to provide incident illumination at a corresponding angle to provide output illumination parallel to (or with the correction of FIG. 6C relative to) the optical axis of the microscope. This geometry, although somewhat more complex to implement, makes a larger proportion of the surface area of the substrate available for positioning reflectors 26 without one reflector obscuring part of the next reflector in line.

FIGS. 9A and 9B illustrates a further geometrical variation wherein a plurality of reflectors 26 are mounted at differing heights above a base plane of the substrate supporting them. This option can be used alone, or as shown here in combination with the angled illumination feature of FIG. 8, to further enhance the total usable reflector area which can be made available. The total height of the structure may be reduced by providing illumination from two or more directions.

Turning now to FIGS. 10-12, there is shown schematically a further set of implementations of the present invention wherein each reflector 26 has a reflective surface with an aperture 40 formed therein, and the corresponding optical sensor 30 is deployed to receive radiation returned from the illuminated spot via aperture 40. This implementation preferably avoids the optical misalignment addressed in FIGS. 6A-6C above by employing spatial subdivision between the illumination and return radiation paths while maintaining exact coincidence of the optical axes for both paths. At the same time, the optical efficiency is preferably rendered far greater than possible with a beam splitter by using highly reflective reflector surfaces in combination with a specially chosen beam intensity profile produced by the DOE 36, as will now be described.

Specifically, referring to FIG. 12, this implementation preferably employs a DOE which generates an array of illumination beams 36′ each with a non-uniform (and non-Gaussian) intensity profile where most of the illumination intensity is concentrated in a hollow cylindrical path. After passing through microlens 38, the beam is focused so as to provide a virtual pinhole effect as described above and then diverges towards the surface of the reflector 26. The non-uniform intensity distribution is configured such that a proportion of the radiation intensity falling on the reflective surface around aperture 40 is greater than a ratio of the reflective surface area to the aperture area. Preferably, in excess of 80% of the illumination intensity of the beam is incident on the reflective surface. Since the beam is once again focused by the objective lens towards the target spot on the specimen, the non-uniform intensity distribution of the beam has no effect on the final illumination pattern. In the return optical path, aperture 40 is preferably sufficiently large that is allows a majority of light returned from the target spot by the objective lens to reach the small area sensor 30.

The technology of beam-shaping by use of a DOE is well developed and devices for various beam intensity profiles are commercially available, both as standard items and customized to particular specifications, from Holo-Or Ltd. of Rehovot, Israel, and other sources.

It will be appreciated that the above descriptions are intended only to serve as examples, and that many other embodiments are possible within the spirit and the scope of the present invention.

1. A microscope arrangement for simultaneously inspecting a plurality of spots on the surface of a substrate, the arrangement having an optical axis substantially perpendicular to the surface, the arrangement comprising:
(a) at least one source of substantially parallel illumination directed non-parallel to said optical axis:
(b) an optical arrangement configured for directing said substantially parallel illumination to illuminate spaced apart spots on the surface of the substrate and for returning radiation from the spots, said optical arrangement including an array of reflectors located and angled so as to generate an array of spaced illumination beams substantially parallel to said optical axis, each reflector reflecting at least 90% of incident radiation intensity; and
(c) an array of optical sensors, each of said sensors being spatially associated with a corresponding at least one of said reflectors so as to receive at least part of the radiation returned from the spot illuminated by the corresponding reflector.

2. The microscope arrangement of claim 1, wherein said at least one source of illumination is implemented as a single source of illumination.

3. The microscope arrangement of claim 1, wherein said at least one source of illumination is configured to provide illumination having a wavelength no greater than 266 nm.

4. The microscope arrangement of claim 1, wherein said array of reflectors and said array of optical sensors are arranged on a common substrate.

5. The microscope arrangement of claim 4, wherein each of said reflectors is adjacent to the corresponding one of said optical sensors.

6. The microscope arrangement of claim 4, wherein each of said optical sensors has a pair of said reflectors deployed on opposing sides of said optical sensors and wherein said at least one source of substantially parallel illumination provides illumination in two incident directions.

7. The microscope arrangement of claim 4, wherein each of said reflectors has a reflective surface with an aperture formed therein, wherein the corresponding one of said optical sensors is deployed to receive radiation returned from the spot via said aperture.

8. The microscope arrangement of claim 7, wherein said optical arrangement further includes a diffractive optical element deployed for generating a plurality of illuminating radiation beams, each of said beams being directed towards one of said reflectors, each of said radiation beams having a non-uniform intensity distribution such that a proportion of said radiation intensity falling on said reflective surface around said aperture is greater than a ratio of said reflective surface area to said aperture area.

9. The microscope arrangement of claim 4 wherein said optical arrangement further includes a diffractive optical element deployed for generating a plurality of illuminating radiation beams, each of said beams being directed towards one of said reflectors.

10. The microscope arrangement of claim 4, wherein said optical arrangement further includes a microlens associated with each of said reflectors and deployed to focus parallel illumination to provide a pinhole illumination effect.

11. The microscope arrangement of claim 4, wherein each of said reflectors has a reflecting surface, a normal to said reflecting surface being at 45° to said optical axis.

12. The microscope arrangement of claim 4, wherein each of said reflectors has a reflecting surface, a normal to said reflecting surface being at less than 45° to said optical axis.

13. The microscope arrangement of claim 4, wherein said substrate has a base plane, wherein a plurality of said reflectors are mounted at differing heights above said base plane.
